(19) United States
(12) Patent Application Publication
(10) Pub. No.: US 2016/0004948 A1
(43) Pub. Date: Jan. 7, 2016

(54) Method for Producing a Paper Carrier Card with Removable Integrated Chip Module Card, and Paper Carrier Card Made of Paper with Removable Integrated Chip Module Card

(71) Applicants: MÜHLBAUER GMBH & CO. KG, Roding (DE); NEW COLORPLAST AG, Pfaeffikon (CH)

(72) Inventors: EMIL GOETZ, UNTERENSTRINGEN (CH); MILENKO VASIC, GEROLDSUND (CH); RICHARD STEIF, SCHORNDORF (DE); GUENTER LANKES, CHAM (DE)

(21) Appl. No.: 14/766,968

(22) PCT Filed: Feb. 13, 2014
(86) PCT No.: PCT/EP2014/052834

§ 371 Date: Aug. 10, 2015

(30) Foreign Application Priority Data
Feb. 14, 2013 (DE) 10 2013 002 536.2

(51) Int. Cl. G06K 19/077; B29C 65/00

(52) U.S. Cl. CPC G06K 19/07747; B29C 66/01; B29C 65/002; G06K 19/07722

(57) ABSTRACT

A method for producing a carrier card with a removable integrated chip-module card(s), where the carrier card is in an ID-1 format and is made of a single-layer or multilayer paper, and where the individual layers have predetermined material properties, and are joined by a waterproof adhesive. The method includes
producing a single-staged or multistaged cavity,
shaping the removable integrated chip-module card(s) in a mini-SIM, micro-SIM, nano-SIM and/or embedded-SIM format with notched or through-notched features and/or webs between each removable integrated chip-module card(s) and the carrier card, and
adhesive bonding of an integrated chip module into the cavity.

### BACKGROUND

Herein a method will be described for producing a paper carrier card with detachable integrated chip-module card, for example in the form of a SIM card or such like, with a single-layer or multilayer body. Furthermore, a paper carrier card made of paper with a detachable integrated chip-module card will be described. Integrated chip-module cards or SIM (subscriber identity module) cards may have varying dimensions: “Full size” see ISO/IEC 7810: 2003, ID-1 “mini SIM” see ISO/IEC 7810:2003, ID-000, “micro SIM” see ETSI TS 102 221 V9.0.0=“mini UICC”, “nano SIM” see ETSI TS 102 221, TS 102 221 V11.0.0, and “embedded SIM” see JEDEC Design Guide 4.8.

Ordinarily, SIM-card holders that serve as transport supports for the SIM cards for mobile phones are produced from plastic. For use, the SIM cards are released from the transport support and inserted into the mobile phone. The rest of the SIM-card holder—that is to say, the transport support—is disposed of. In 2011 alone, more than 5 billion such plastic cards were produced worldwide.

### STATE OF THE ART

DE 199 21 525 C2 relates to a chip card with a chip-module card that can be taken out. Here, a card is generated by punching or cutting, the punching process or cutting process being controlled in such a way that after the punching process or cutting process a core is preserved which continues to connect the card to the card body of the chip card. A recess serves to facilitate the extraction of the card from the card body. By way of material for the card body of the chip card, mentioned here, in particular, is paper, paperboard or cardboard with sufficient elasticity, this being preferable from an environmental viewpoint, particularly in view of the fact that the card body of the chip card is, as a rule, disposed of after the card has been taken out.

DE 101 56 555 A1 relates to a card in which a recess has been provided for receiving a miniature module (e.g. a micro-SIM card) provided with an electronic circuit. The miniature module is formed by potting in the carrier, and forms an independent part, recessed so as to be capable of being taken out, formed in a cut-out of the carrier designed to be complementary to the shape of the module. The carrier consists of paperboard, rigid paper or an equivalent material.

EP 0 742 926 B1 relates to a single-layer or multilayer data carrier, in particular IC cards, with embedded electronic module which serves for the exchange of data with an external appliance, said data carrier consisting of paper and/or cardboard.

In this case, the layers of paper needed for the structure of the card, regardless of whether it is a question of a single-layer or multilayer card, are provided from a roll, as a result of which the paper IC card has to be manufactured by a continuous method. The several layers are adhesion-bonded, either cold or with the aid of thin, thermally activated adhesives. This IC card can, for example, be printed on with an inkjet printer.

In a variant of the production process described therein, a large sheet of paper and/or cardboard is provided, from which a plurality of cards are produced. However, in this connection there is the problem of causing the worked-out contours of the individual layers to coincide precisely.

In a card body consisting of several layers of paper or of a layer of cardboard the electronic module is glued in, or the electronic module is laminated into the card body during production of the cards, by the module being either embedded between two layers or glued into a recess.

A multilayer card structure arises as a result of lamination of an upper covering layer, of a core layer and of a lower covering layer. The core layer has been provided on both sides with a thin, thermally activated layer of adhesive in order to bond the layers. Before the individual layers are brought together, windows are punched into the layers, so that a two-stage recess is formed in the card body after the three layers have been brought together and bonded. The layers are provided from rolls and for the purpose of lamination are conducted through heated laminating rollers, between which the thermally activated layers of adhesive are activated. In this way, a continuous laminate arises which has been provided at appropriate intervals with the recesses for receiving the electronic module. From this continuous laminate the individual card bodies are punched out in a further process step. The electronic modules are glued into the recess of the card body. The module is inserted into the card body before or after the card is punched out.

However, this procedure has the disadvantage that even in the case of small positional deviations the recess contours of the individual layers are no longer aligned and the edges are frayed.

DE 694 28 648 T2 relates to an IC card with a separable minicard, and to methods for production of the same. In this case the IC card has a plate frame made of paper materials, such as, for example, wood-free paper, coating paper and resin-impregnated paper, synthetic or plastic leaves consisting of resin, such as, for example, polyvinyl chloride, polyethylene terephthalate, polyvinyl-chloride-acetate copolymer, polystyrene and acrylonitrile-butadiene-styrene copolymer.

EP 2 521 073 A1 relates to a method for producing a card with a microcircuit and with a card body surrounding said microcircuit, wherein slots are cut into the card body along the contour of the card, said slots being separated by connecting elements which connect the card to the surrounding card body. The card body consists of a cellulose-based material.

Further technological background can be gathered from CN 2014 38 312 U or from JP 2001 357 376 A.

None of the previous variants has hitherto gained acceptance on the market, although there is a considerable demand for ecologically more compatible solutions in the case of SIM cards. This is presumably also made difficult by the lack of precision, resulting from the paper material, in the course of producing the paper carrier cards with detachable integrated chip-module card. However, this is playing a heightened role with increasing miniaturisation of the cards. For instance, both in the production of multilayer paper carrier cards from a sheet and in their production from roll to roll the problem arises that the paper warps. Hence the recesses of the individual layers have not been oriented exactly with respect to one another so as to be aligned, leading to problems in the course of the subsequent mounting of the chip module in the cavity formed by the recesses.

### Underlying Object

The object consists in providing an inexpensive arrangement, to be produced quickly and durably, for a paper carrier card with detachable integrated chip-module card. The object consists, in addition, in specifying a simple and inexpensive method for producing the paper carrier card with detachable integrated chip-module card and also in specifying an apparatus for producing the paper carrier card with detachable integrated chip-module card.

### Proposed Solution

The object is achieved by a carrier card (a SIM-card holder) made of paper. In this way, a completely recyclable, environmentally friendly SIM-card holder made of paper arises which, moreover, has lower production costs and is easier to print on.

To this end, the method for producing a carrier card with detachable integrated chip-module card has the following steps:

providing a carrier card in the ID-1 format consisting of a single-layer or multilayer paper, wherein the individual layers exhibit predetermined material properties and the individual layers have been connected with water-resistant adhesive,

(a) producing a cavity, the cavity having one or more stages, so that at least an outer and an inner partial cavity are formed, by

(a1) first notching of the carrier card along a contour of the outer partial cavity to be introduced into the carrier card;

(a2) removing paper material within the first contour for the purpose of producing the outer partial cavity to be introduced into the carrier card;

(a4) removing paper material within a second contour of the inner partial cavity to be introduced into the carrier card;

(b) shaping the detachable integrated chip-module card(s) in the mini-SIM, micro-SIM, nano-SIM and/or embedded-SIM format with notches or through-notches and/or ridges between each of the detachable integrated chip-module cards and the rest of the carrier card; and

(c) gluing an integrated chip module into the cavity.

This procedure permits the production of a positionally accurate cavity in a paper carrier card and the production of a paper carrier card with detachable chip-module card.

Steps (a2) and (a4), removing paper material, may be undertaken in a variant by first milling within the first contour and/or by second milling within the second contour.

In another variant, prior to step (a4) a step (a3), second notching of the carrier card along the second contour of the inner partial cavity to be introduced into the carrier card, may be undertaken.

In a further variant, the provision of a carrier card made of a multilayer paper may include the condition that the individual layers of paper in the region of the cavity to be produced have not been bonded.

In this case, steps (a2) and (a4), removing paper material by first extraction by suction of the paper material within the first contour and/or by second extraction by suction of the paper material within the second contour, may be undertaken.

Step (c), gluing an integrated chip module into the cavity, may be executed before or after step (b), shaping the detachable integrated chip-module card(s) between each of the detachable integrated chip-module cards and the remaining carrier card.

The first and/or the second notching may each be undertaken to a depth that corresponds at least to the depth of the respective outer or inner partial cavity.

The cards can be inscribed with a laser beam. Alternatively or additionally, in the case of a card coated with dye the laser beam removes a part of the dye in the form of the inscription.

In contrast to the procedure in the state of the art, for example EP 0 742 926 B1, in the case of the procedure presented herein the paper is not processed in the sheet format or from the roll, but rather each card is machined individually. This has proved to be a procedure considerably enhancing accuracy in the course of production of the cavity, so that the precision of the overall process, including the gluing of the integrated chip module into the cavity, has been significantly increased. Hence the proportion of unacceptable carrier cards in production also falls.

This is due to the fact that in the state of the art the positioning of the punched cut-outs relative to one another and the spacing of the subsequently punched-out card of the integrated chip module from the edge of the cards are too inaccurate and difficult to reproduce in practice. In the sheet format, in addition it is difficult in the next process step to find exactly the position now to be milled and previously prepunched/notched.

In contrast, it is proposed herein that the first and the second notching are each undertaken to a depth that corresponds at least to the depth of the respective outer or inner partial cavity. In this connection the notching may be undertaken in each instance to a depth of about 200-300 microns. In the case of a multilayer card, the notching can be undertaken in each instance to a depth that corresponds to the thickness of the respectively notched layer of paper. In the case of a multilayer card, the milling is undertaken in each instance to a depth that corresponds to the thickness of the respectively notched layer of paper. Accordingly, in each instance one or more layers of paper is/are notched or milled, and a paper surface of the respective layer of paper has been exposed as bottom surface of the (partial) cavity. Accordingly, an accurately milled cavity with a smooth bottom can be achieved. Otherwise the bottom would be uneven, which may have the result that the module to be implanted does not adhere sufficiently or is glued into the cavity inaccurately or with an angle error. In addition, errors of measurement would occur as a result of the unevenness when measuring the depth of the cavity in series manufacture. However, it is also possible not to notch or mill at layer height. In the latter case, one of the variants, described hereinafter, of a milling cutter or cutting tool or peeling tool is advantageous, on account of the shape of the (partial) cavities to be achieved therewith and on account of the smooth walls of the (partial) cavities which are likewise achievable therewith.

Since with the procedure presented herein only the already complete carrier card is provided with the cavity, by the latter being worked out of the material, which is then present in planar form, of a single card, by virtue of the procedure proposed herein both the position of the cavity and the shape thereof are considerably more accurate than in the state of the art.

A paper material that is well-suited for the production of the proposed carrier card is “Oppboga Green Card” with a

| Quantity | Test Specification | Unit | Value |
|---|---|---|---|
| Grammage | DIN EN ISO 536 | g/m² | 10-800 |
| Thickness | DIN EN ISO 534 | μm | 10-800 |
| Flexural Stiffness | DIN EN ISO 5629 | mNm | |
| Resonance mNm | | | |
| MD | | | 200-300, e.g. |
| | | | 309 |
| CD | | | 120-200, e.g. |
| | | | 167 |
| Roughness | DIN EN ISO 8791-4 | PPS, μm | 0.8-1.2, e.g. |
| | | | 1.0 |
| CIE Whiteness (D65/10°) | DIN EN ISO 11 475 | | 124 |
| Structural Strength (Scott | Tappi 569 | J/m² | 100-300, e.g. |
| bond) | | | 200 |

In the case of a multilayer carrier card, use is made of three or more (for example, 4 or 5, or up to 10) layers of paper with varying or equal thickness.

If use is made of this paper and, in the case of a multilayer structure of the carrier card, use is made of a water-resistant adhesive for connecting the layers of paper, a composite is available that is capable of being notched and milled out or peeled out very precisely. The machining of this paper or paper composite leads to considerably better results in terms of accuracy. This results in less wastage in series production, since the chip module is to be inserted into a precisely manufactured cavity also with more foreseeable success. This paper enables an accurately milled cavity with a smooth bottom to be achieved; this is less readily possible with other papers. The bottom of the cavity would be uneven, which could lead to impaired adhesion and alignment of the chip module in the cavity.

In the course of producing the carrier card with detachable integrated chip-module card, steps (a), (b) and (c) may be executed in the order (a), then (b), and then (c), or in the order (a), then (c), and then (b), or in the order (b), then (a), and then (c).

Steps (a1), (a2), (a3) and (a4) may be executed in the order (a1), then (a2), then (a3), and then (a4), or in the order (a1), then (a3), then (a2), and then (a4).

In a variant, step (a4) is undertaken before step (a2). In the course of this procedure, regions of unevenness at the edges of the inner cavity—to the extent that they have arisen—are partly removed at the same time in the course of generating the larger cavity. In addition or instead of this, step (a4) may be undertaken before step (a1).

Steps (a1) and (a3) may be executed with the following notching parameters: notch angle: 5-15 degrees outwards and 25-35 degrees inwards. In a variant, use is made of a notch angle of 40 degrees.

Steps (a2) and (a4), removing paper material within the first and the second contour for the purpose of producing the outer and inner partial cavity to be introduced into the carrier card, are preferably executed in such a way that the outer partial cavity and the inner partial cavity respectively have a frustoconical outer circumferential surface and inner circumferential surface tapering towards the bottom of the cavity with a cone angle between 12 degrees and about 20 degrees or 25 degrees. This shape is preferentially realised with an appropriately shaped and dimensioned cutting tool or milling tool. In this connection, the inclination of the frustoconical outer circumferential surface and inner circumferential surface tapering towards the bottom of the cavity can bring about a more precise shaping of the cavity in the paper material. Moreover, by virtue of the oblique outer circumferential surface and inner circumferential surface the lateral area of adhesion of the hot-melt adhesive and of the embedding material increases.

In the case of a chip-module card described herein with a multilayer card, the papers for the individual layers have varying or equal thickness.

The chip-module card described herein with a multilayer card is detachable from a carrier card. In this case a chip module has been received in a cavity having an outer and an inner partial cavity, the outer partial cavity and/or the inner partial cavity respectively having a frustoconical outer circumferential surface and inner circumferential surface tapering towards the bottom of the cavity with a cone angle between 12 degrees and about 20 degrees.

### BRIEF DESCRIPTION OF THE DRAWING

Further objectives, features, advantages and application options result from the following description of some embodiments and associated drawings. In this connection, all the features described and/or represented pictorially, on their own or in arbitrary combination, form the subject-matter disclosed herein, also irrespective of their grouping in the claims or their subordinating references.

FIG. 1 shows a schematic top view of a carrier card with detachable integrated chip-module card with notches and ridges between each detachable integrated chip-module card and the rest of the carrier card.

FIG. 2 shows schematically the carrier card from FIG. 1 in a sectional view along line A-A in FIG. 1.

FIG. 3-FIG. 7 show, schematically, steps of a method for production of the carrier card from FIG. 1.

FIG. 8 shows schematically a peeler with indexable insert for removing paper material from the two partial cavities, wherein FIG. 8a shows a frontal top view and FIG. 8b shows an enlarged side view of the indexable insert.

FIG. 9 shows schematically the notching knife employed in FIGS. 3-7 in a lateral sectional view.

FIG. 10 shows schematically a machine in which the steps illustrated in FIGS. 3-7 are executed.

FIG. 11 shows schematically, in varying views, a cutting/milling tool for working out the partial cavities with obliquely inclined frustoconical circumferential surfaces tapering towards the bottom of the cavity.

### DETAILED DESCRIPTION

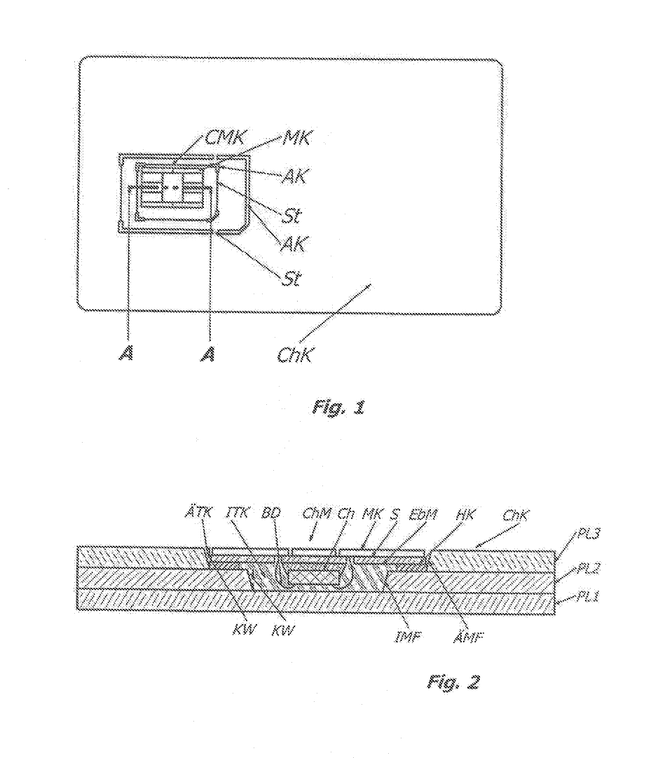

Illustrated in FIG. 1 is a carrier card TK in the ID-1 format with a detachable integrated chip-module card CMK which serves as subscriber identity module. In this case the chip-module card CMK has been surrounded by notches AK and ridges St. With a view to more versatile applicability of the chip-module card CMK, the notches AK and ridges St have been arranged around the chip-module card CMK in such a way that the chip-module card CMK in varying formats is detachable from the carrier card TK. The variant shown here includes a carrier card TK, out of which a chip-module card CMK either in the mini-SIM card format or in the micro-SIM card format can be broken out. But other or further card-format combinations are also possible.

The carrier card TK in the ID-1 format in the present variant has been constructed from a multilayer paper, more precisely a three-ply paper, the individual layers PL1, PL2, PL3 of which have predetermined material properties and have been connected in planar manner with a water-resistant adhesive.

As also illustrated in FIG. 2, in the carrier card TK a cavity K has been formed which here is of multi-stage construction, more precisely two-stage construction. Accordingly, an outer partial cavity ÄTK and an inner partial cavity ITK have been formed. In this case the inner partial cavity ITK extends from an upper side OS of the carrier card TK through the upper and the middle layer of paper PL3 and PL2 as far as the lower layer of paper PL1. In comparison with the outer partial cavity ÄTK, the inner partial cavity ITK has—in top view—a smaller (approximately circular) cross section. The outer partial cavity ÄTK extends from the upper side OS of the carrier card TK through the upper layer of paper PL3 to the middle layer of paper PL2. In comparison with the inner partial cavity ITK, the outer partial cavity ÄTK has—in top view—a larger cross section, the shape of which in top view corresponds roughly to the respective chip module ChM glued into the cavity, more precisely the contact layout thereof. In this connection, in the variant illustrated here the outer partial cavity ÄTK and the inner partial cavity ITK respectively have a frustoconical outer circumferential surface ÄMF and inner circumferential surface IMF tapering towards the bottom of the cavity. In this case, both circumferential surfaces ÄMF, IMF have a cone angle KW between 12 degrees and about 20 degrees; in the present variant the cone angle KW is about 15° with respect to the perpendicular drawn with a broken line in FIG. 2. In this case, only one of the two partial cavities may have a frustoconical outer circumferential surface ÄMF or inner circumferential surface IMF tapering towards the bottom of the cavity, whereas the respective other of the two partial cavities has a perpendicular or approximately perpendicular circumferential surface. By ‘approximately perpendicular’ here, a circumferential surface is understood, the inclination of which with respect to the perpendicular amounts to about 10° or less.

The chip module ChM glued into the cavity has a substrate S, on the upper (out)side of which in FIG. 2 several metallic contact surfaces MK have been formed. On the lower (in)side of the substrate S in FIG. 2 a chip Ch which contains a simple microprocessor with memory has been glued in the centre of said substrate by means of a chip adhesive ChK. With a Personal Identification Number PIN, this chip can be protected against unauthorised use. By virtue of the SIM, a mobile phone is registered in a mobile radio network and authenticated therein. For this purpose, the memory of the SIM contains personal numbers and algorithms in stored form, which also serve for encryption of the transmitted voice data and other data.

Through openings in the substrate S, bonding wires BD extend to the chip Ch from the lower (in)side of the metallic contact surfaces MK in FIG. 2. The chip Ch and the bonding wires BD have been received in an embedding material EbM which protects the chip Ch and the bonding wires BD electrically and mechanically against environmental influences.

Illustrated in FIGS. 3-7 is a possible variant of the method for producing a carrier card with detachable integrated chip-module card.

According to FIG. 3, an individual carrier card in the ID-1 format consisting a multilayer—here, three-ply—paper is provided. The individual layers have predetermined material properties elucidated further below. The individual layers of the paper have been firmly connected with water-resistant adhesive.

Firstly, a cavity is formed, the cavity being in one or more stages—here, two stages. For this purpose, an outer and an inner partial cavity are formed.

As shown in FIG. 3, the individual carrier card is firstly subjected to a first notching along a contour of the inner partial cavity to be introduced into the carrier card. For this purpose, an annular first notching knife is lowered into the individual carrier card in order to make a notch in the upper and middle layers of paper PL3 and PL2 in FIG. 3. In this case the first notching knife is lowered so far into the composite of the three layers of paper PL1, PL2, PL3 that the notching edge of the first notching knife makes a notch through as far as the upper surface of the lowest layer of paper PL1.

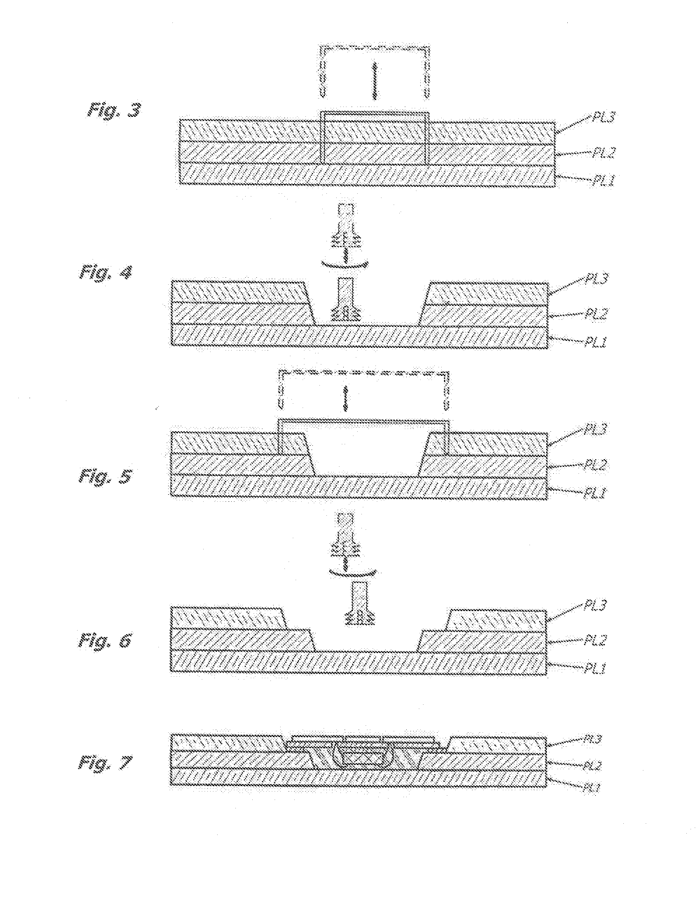

Subsequently, as illustrated in FIG. 4, the individual carrier card is subjected to a removal of paper material within the first contour, in order to produce the inner partial cavity to be introduced into the card carrier. For this purpose, a milling head is set in rotation and is moved into the region of the upper and middle layers of paper PL3 and PL2 that has been gouged out by the first notching knife. The milled-out paper material can be removed by suction.

As next steps, FIGS. 5 and 6 show the removal of paper material within a second contour of the outer partial cavity to be introduced into the carrier card. In this connection, firstly, analogously to the step shown in FIG. 3, the individual carrier card is subjected to a second notching along a contour of the outer partial cavity to be introduced into the carrier card. For this purpose, an annular second notching knife is lowered into the individual carrier card in order to make a notch in the upper layer of paper PL3 in FIG. 5. The second notching knife has a larger cross section than the first notching knife. The second notching knife is lowered so far into the uppermost layer of paper PL3 that the notching edge of the second notching knife notches through as far as the upper surface of the middle layer of paper PL2 in FIG. 5.

After this, as illustrated in FIG. 6, the individual carrier card is subjected to a removal of paper material within the second contour in order to produce the outer partial cavity to be introduced into the card carrier. For this purpose, a milling head is set in rotation and is moved into the region of the upper layer of paper PL3 that has been gouged out by the second notching knife. The milled-out paper material can be removed by suction.

Prior to insertion of the chip module, the shaping is undertaken of the detachable integrated chip-module card(s) in the mini-SIM card format and micro-SIM card format with the notches and through-notches and ridges illustrated in FIG. 1 between the detachable integrated chip-module card and the rest of the carrier card. This purpose is served by notching knives or milling cutters, not illustrated here in any detail, with which the carrier card is appropriately machined.

Finally, the gluing of the integrated chip module into the cavity is undertaken. In this process a hot-melt adhesive HK is applied onto the stepped transition St between the inner and the outer partial cavity, which fastens the substrate S of the integrated chip module securely and in dimensionally stable manner in the edge region on the stepped transition St. In this process, by virtue of the precise shaping of the step at the transition between the inner and the outer partial cavity, and by virtue of the shape and the dimensions of the cavity worked out exactly by the notching and milling processes presented herein, it is guaranteed that the exposed upper side of the metallic contacts of the integrated chip module terminates flush with its surroundings in the integrated chip-module card. Accordingly, it is ensured that a chip-module card inserted into an electronic appliance (mobile phone, tablet computer, etc.) does not get caught on an edge during insertion and thereby get damaged.

Similarly, it is ensured by the embedding material of the integrated chip module together with the lowest layer of paper PL1 that the chip and the bonding wires thereof are well protected in the cavity also from the underside of the chip-module card. In particular, the shape and the dimensions of the cavity have also been worked out exactly by the notching and milling processes presented herein. This also prevents, for example, the integrated chip module from resting asymmetrically on the bottom by virtue of regions of unevenness of the bottom of the inner partial cavity. This would disadvantageously have the consequence that the exposed upper side of the metallic contacts MK of the integrated chip module does not terminate flush with its surroundings in the integrated chip-module card but is inclined relative to the surface of the chip-module card and accordingly partly protrudes from the latter or does not reach the edge thereof.

In contrast, the procedure described herein ensures that the exposed upper side of the metallic contacts of the integrated chip module terminates flat and flush with its surroundings in the integrated chip-module card.

The chip-module card may have been shaped with varying slots and ridges in the carrier card. Optionally, the ridges that hold the chip-module card in the carrier card may also have been notched. In a variant, the method begins with the punching of the outlines of the chip-module card, and only then are notching/prepunching, milling and implanting carried out. For reasons of accuracy and stability it is advantageous firstly to notch/mill and to implant, and only then to punch the outlines of the chip-module card into the carrier card. But other sequences also work. However, it is preferred to punch the outlines prior to implantation, in order not to subject the chip module to any unnecessary loading or vibration.

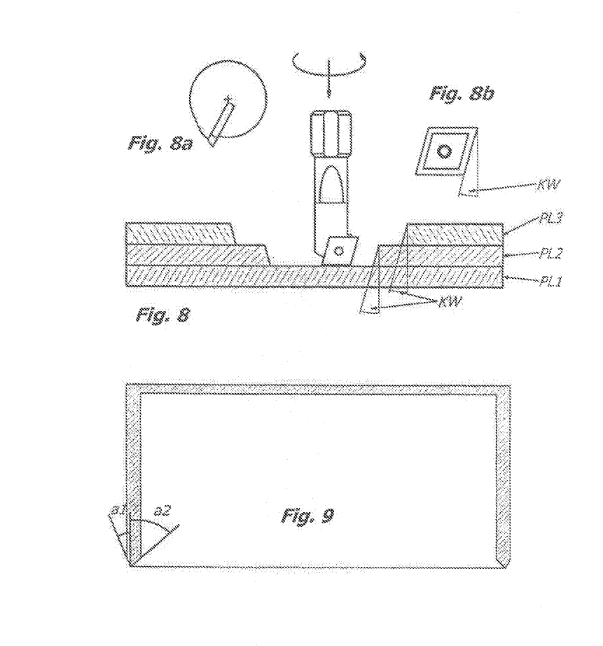

Instead of the milling cutter, a peeler, for example with indexable insert, can also be employed for the purpose of removing paper material within the first and/or the second contour of the two partial cavities. On this point, see the tool illustrated schematically in FIG. 8.

In order to produce a carrier card with detachable integrated chip-module card of the type presented herein so that it is particularly dimensionally accurate and true to shape, a cellulosic material with the following properties is used as paper:

| Quantity | Test Specification | Unit | Value |
|---|---|---|---|
| Grammage | DIN EN ISO 536 | g/m² | 10-800 |
| Thickness | DIN EN ISO 534 | μm | 10-800 |
| Flexural Stiffness | DIN EN ISO 5629 | mNm | |
| Resonance mNm | | | |
| MD | | | 200-300, e.g. |
| | | | 309 |
| CD | | | 120-200, e.g. |
| | | | 167 |
| Roughness | DIN EN ISO 8791-4 | PPS, μm | 0.8-1.2, e.g. |
| | | | 1.0 |
| CIE Whiteness (D65/10°) | DIN EN ISO 11 475 | | 124 |
| Structural Strength (Scott | Tappi 569 | J/m² | 100-300, e.g. |
| bond) | | | 200 |

The schematic representation of the carrier card in the Figures elucidated above is correct in terms of proportions, to the extent that papers of equal thickness are used here for the individual layers. This allows a simple production of the individual cards. It was already explained at the outset that the sequence of the individual steps may be varied. In addition, individual steps may be omitted.

For the purpose of removing paper material within the first and the second contour for the purpose of producing the outer and inner partial cavity to be introduced into the carrier card, in a variant a milling cutter or a cutting tool can be used that has been designed in such a way that the outer partial cavity and the inner partial cavity respectively have a frustoconical outer circumferential surface and inner circumferential surface tapering towards the bottom of the cavity with a cone angle between 12 degrees and about 20 degrees. Preferentially the geometry of the milling cutter or of the cutting tool is such that by virtue of the cutting/milling tool the outer partial cavity and the inner partial cavity respectively have a frustoconical outer circumferential surface and inner circumferential surface tapering towards the bottom of the cavity with a cone angle of 15 degrees.

Depending on the shape of the chip module, the outer partial cavity and the inner partial cavity may respectively have a frustoconical outer circumferential surface and inner circumferential surface tapering towards the bottom of the cavity. However, it is also possible to configure only one of the two partial cavities with a tapering frustoconical circumferential surface.

The notching knife may have the following characteristics: the notching knife has a circular hollow-cylindrical blade with a blade height of about 3-10 mm and a blade thickness of about 0.2-1.2 mm; its notching edge is asymmetrically shaped, being inclined outwards at an angle a1 of around 5-25 degrees relative to the perpendicular, 20 degrees outwards in the example shown in FIG. 9, and at an angle a2 of 25-55 degrees inwards relative to the perpendicular, in the example shown in FIG. 9, inclined about 40 degrees inwards. These figures apply both to the notching knife for the inner partial cavity and to the notching knife for the outer partial cavity.

If in the notched region in the extent of the outer partial cavity firstly the smaller, deeper inner partial cavity is milled out and subsequently, corresponding to the size of the notched region, the second, larger, less deep partial cavity is milled, this has the advantage that a burr which has arisen in the smaller, deeper partial cavity is milled away. The milling tool may be made of standard hard metal.

The carrier card preferably has one or more register marks or reference edges for positioning the notching knives and the milling cutters or peelers in the X- and Y-coordinates. Then, in each machining station (notching/milling or peeling), the carrier card is positioned relative to the same register marks (index marks). Accordingly, the milling contour coincides exactly with the embossing contour, and the positions of the milled cavities relative to the register marks or reference edges of the carrier card lie within the required tolerance.

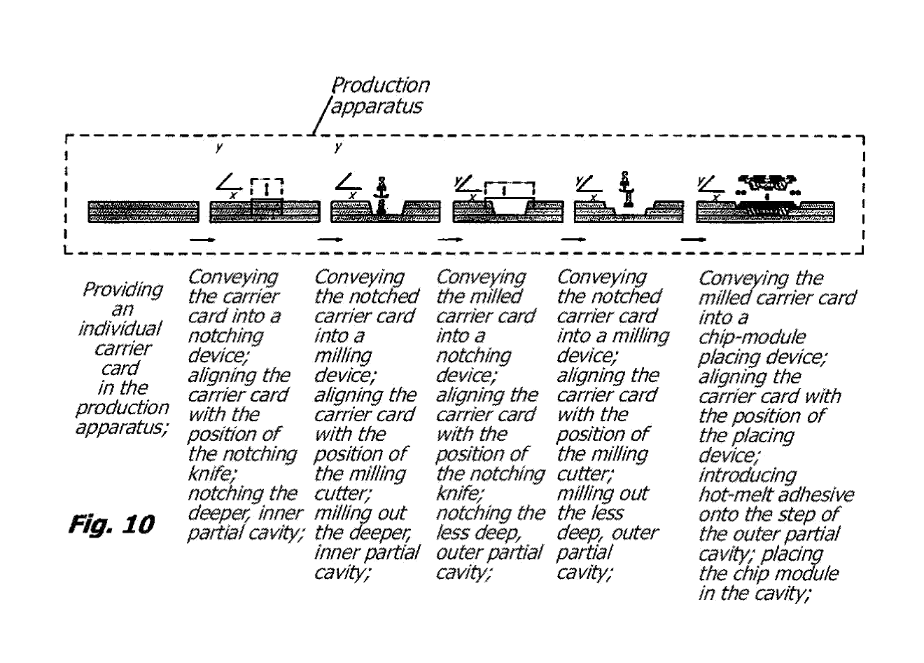

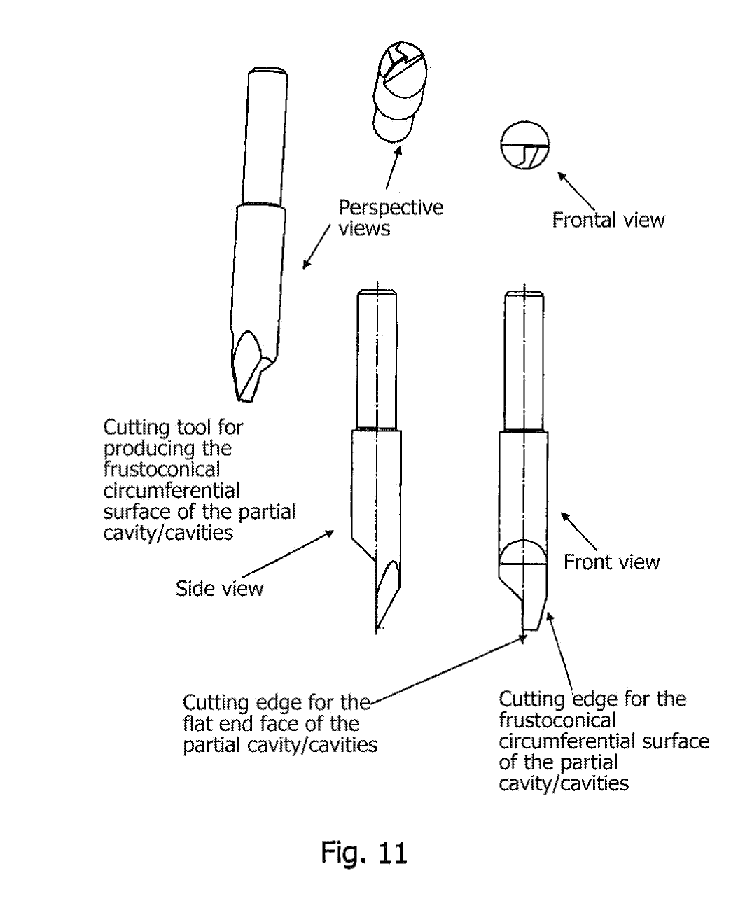

The machine shown schematically in FIG. 10, in which the steps illustrated in FIGS. 3-7 can be executed, may have been realised either as an integral arrangement or as an assembly of individual modules in which the notching knives or milling heads are actuated by appropriate linear drives and rotary drives. The individual modules have been coupled together via a transport device for the individual carrier card and are actuated by a central machine control.

The variants, described in the foregoing, of the method and of the apparatus serve merely for better understanding of the structure, the mode of operation and the properties of the solution that has been presented; for instance, they do not restrict the disclosure to the embodiments. The Figures are schematic, wherein essential properties and effects have been represented, in part in clearly enlarged form, in order to clarify the functions, active principles, technical configurations and features. In this connection, every mode of operation, every principle, every technical configuration and every feature that has/have been disclosed in the Figures or in the text can be combined, freely and arbitrarily, with all the claims, with every feature in the text and in the other Figures, with other modes of operation, principles, technical configurations and features that are contained in this disclosure or result therefrom, so that all conceivable combinations are to be attributed to the described solution. In this connection, combinations of all the individual statements in the text—that is to say, in every section of the description—in the claims and also combinations of different variants in the text, in the claims and in the Figures are also encompassed.

The details of the apparatus and of the method elucidated above have been represented in context; however, let it be pointed out that they are also independent of one another and can also be freely combined with one another. The ratios, shown in the Figures, of the individual parts and sections thereof to one another, and the dimensions and proportions thereof, are not to be understood as being restricting. Rather, individual dimensions and proportions may also differ from those shown.

The claims also do not limit the disclosure and therefore the possibilities for combination of all the demonstrated features with one another. All the demonstrated features have been explicitly disclosed herein, both individually and in combination with all other features.

1. A method for producing a carrier card with a detachable integrated chip-module card, comprising the following steps:
providing a carrier card in an ID-1 format including a single-layer or multilayer paper, wherein the individual layers exhibit predetermined material properties,
and the individual layers have been connected with a water-resistant adhesive,
(a) producing a cavity having one or more stages, so that at least an outer and an inner partial cavity are formed, by
(a1) first notching the carrier card along a contour of the outer partial cavity to be introduced into the carrier card;
(a2) removing paper material within a first contour of the outer partial cavity to be introduced into the carrier card;
(a4) removing paper material within a second contour of the inner partial cavity to be introduced into the carrier card;
(b) shaping one or more detachable integrated chip-module cards in a mini-SIM, micro-SIM, nano-SIM and/or embedded-SIM format with notches or through-notches and/or ridges between each detachable integrated chip-module card and the rest of the carrier card; and
(c) gluing an integrated chip module into the cavity.

2. The method for producing a carrier card with a detachable integrated chip-module card according to claim 1, wherein:
removing paper material by first milling within the first contour, and/or by second milling within the second contour are undertaken, and/or wherein prior to step (a4) a step (a3), second notching of the carrier card along the second contour of the inner partial cavity to be introduced into the carrier card,
is undertaken, and/or wherein
the carrier card consisting of a multilayer paper includes a condition that the individual layers of paper in the region of the cavity to be produced have not been bonded.

3. The method for producing a carrier card with a detachable integrated chip-module card according to claim 2, wherein steps:
(a1) and (a4), removal of paper material by
first extraction by suction of the paper material within the first contour, and/or by
second extraction by suction of the paper material within the second contour, are undertaken.

4. The method for producing a carrier card with a detachable integrated chip-module card according to claim 2, wherein
the first and/or the second notching are each undertaken to a depth that corresponds at least to the depth of the respective outer or inner partial cavity, and/or wherein
the notching is undertaken in each instance to a depth of about 200-300 microns, and/or wherein
the milling is undertaken in each instance to a depth of about 200-300 microns, and/or wherein
in the case of a multilayer carrier card the notching is undertaken in each instance to a depth that corresponds to the thickness of the respectively notched layer of paper, and/or wherein
in the case of a multilayer carrier card the milling is undertaken in each instance to a depth that corresponds to the thickness of the respectively notched layer(s) of paper.

5. The method for producing a carrier card with a detachable integrated chip-module card according to claim 1, wherein step (c), gluing an integrated chip module into the cavity, is executed before or after step (b), shaping the detachable integrated chip-module card(s) between each of the detachable integrated chip-module cards and a remaining carrier card.

6. The method for producing a carrier card with a detachable integrated chip-module card according to claim 1, wherein a cellulosic material with the following properties is used as the paper:

| Quantity | Test Specification | Unit | Value |
|---|---|---|---|
| Grammage | DIN EN ISO 536 | g/m² | 10-800 |
| Thickness | DIN EN ISO 534 | μm | 10-800 |
| Flexural Stiffness | DIN EN ISO 5629 | mNm | |
| Resonance mNm | | | |
| MD | | | 200-300, e.g. |
| | | | 309 |
| CD | | | 120-200, e.g. |
| | | | 167 |
| Roughness | DIN EN ISO 8791-4 | PPS, μm | 0.8-1.2, e.g. |
| | | | 1.0 |
| CIE Whiteness (D65/10°) | DIN EN ISO 11 475 | | 124 |
| Structural Strength (Scott | Tappi 569 | J/m² | 100-300, e.g. |
| bond) | | | 200 |

7. The method for producing a carrier card with a detachable integrated chip-module card according to claim 1, wherein papers with varying or equal thickness are used for the individual layers in a multilayer carrier card.

8. The method for producing a carrier card with a detachable integrated chip-module card according to claim 1, wherein step (a4) is undertaken prior to step (a2), and/or step (a4) is undertaken prior to step (a1), and/or wherein
steps (a), (b) and (c) are executed
in the order (a), then (b), and then (c), or
in the order (a), then (c), and then (b), or
in the order (b), then (a), and then (c)
and/or wherein steps
(a1), (a2), optionally (a3), and (a4) are executed
in the order (a1), then (a2), optionally then (a3), and then (a4), or
in the order (a1), optionally then (a3), then (a2), and then (a4).

9. The method for producing a carrier card with a detachable integrated chip-module card according to claim 1, wherein steps
(a1) and optionally (a3) are executed with the following notching parameters:
5-15 degrees outwards and 25-35 degrees inwards.

10. The method for producing a carrier card with a detachable integrated chip-module card according to claim 1, wherein steps
(a2) and (a4), removing paper material within the first and the second contour for the purpose of producing the outer and inner partial cavity to be introduced into the carrier card, are executed in such a way that the outer partial cavity and the inner partial cavity respectively have a frustoconical outer circumferential surface and inner circumferential surface tapering towards a bottom of the cavity with a cone angle between 12 degrees and about 20 degrees.

11. An apparatus for producing a carrier card with a detachable integrated chip-module card,
a module for providing a carrier card in an ID-1 format consisting of a single-layer or multilayer paper, wherein individual layers exhibit predetermined material properties and the individual layers have been connected with water-resistant adhesive,
a device for producing a cavity having one or more stages so that at least an outer and an inner partial cavity are formed, with
a first cutting device or separating device for notching the carrier card along a contour of the outer partial cavity to be introduced into the carrier card;
a device for removing paper material within the first contour for the purpose of producing the outer partial cavity to be introduced into the carrier card;
a device for removing paper material within a second contour of the inner partial cavity to be introduced into the carrier card;
a device for shaping the detachable integrated chip-module card(s) in a mini-SIM, micro-SIM, nano-SIM and/or embedded-SIM format with notches or through-notches and/or ridges between each detachable integrated chip-module card and the rest of the carrier card; and
a device for gluing an integrated chip module into the cavity.

12. The apparatus for producing a carrier card with a detachable integrated chip-module card according to claim 11, with
one or two milling devices, in order to remove the paper material by first and/or second milling within the first and/or within the second contour, and/or wherein
a second cutting device or separating device for notching has been provided, in order to notch the carrier card along the second contour of the inner partial cavity to be introduced into the carrier card.

13. The apparatus for producing a carrier card with a detachable integrated chip-module card according to claim 11, which has been set up to process a carrier card, consisting of a multilayer paper, in which the individual layers of the paper have not been bonded in a region of the cavity to be produced, and/or
with a suction box for removing paper material by first extraction by suction of the paper material within the first contour, and/or with a suction box for removing paper material by second extraction by suction of the paper material within the second contour.

14. The apparatus for producing a carrier card with detachable integrated chip-module card according to claim 12, wherein
the first and/or second cutting device or separating device for notching has/have been set up to notch the carrier card in each instance to a depth that corresponds at least to the depth of the respective outer or inner partial cavity, and/or wherein
the first and/or second cutting device or separating device for notching has/have been set up to notch the carrier card in each instance to a depth of about 200-300 microns, and/or wherein the first and/or second cutting device or separating device for notching has/have been set up to notch a depth that corresponds to the thickness of the respectively notched layer of paper or of a part thereof, and/or wherein
the milling device(s) has/have been set up to mill out, in the case of a multilayer card, in each instance to a depth that corresponds to the thickness of the layer of paper respectively to be milled out or of a part thereof, and/or wherein
the device for gluing an integrated chip module into the cavity has been set up to glue on the integrated chip module at the transition between the inner and the outer cavity before or after the detachable integrated chip-module card is shaped out of the rest of the carrier card.

15. The apparatus according to claim 11, wherein a cellulosic material with the following properties is used as the paper:

| Quantity | Test Specification | Unit | Value |
|---|---|---|---|
| Grammage | DIN EN ISO 536 | g/m² | 10-800 |
| Thickness | DIN EN ISO 534 | μm | 10-800 |
| Flexural Stiffness | DIN EN ISO 5629 | mNm | |
| Resonance mNm | | | |
| MD | | | 200-300, e.g. |
| | | | 309 |
| CD | | | 120-200, e.g. |
| | | | 167 |
| Roughness | DIN EN ISO 8791-4 | PPS, μm | 0.8-1.2, e.g. |
| | | | 1.0 |
| CIE Whiteness (D65/10°) | DIN EN ISO 11 475 | | 124 |
| Structural Strength (Scott | Tappi 569 | J/m² | 100-300, e.g. |
| bond) | | | 200 |

16. The apparatus according to claim 11, wherein the chip-module card is a multilayer card and wherein the papers for the individual layers have varying or equal thickness.

17. The apparatus according to claim 11, wherein the chip-module card is a multilayer card and wherein the outer partial cavity and/or the inner partial cavity respectively have a frustoconical outer circumferential surface and an inner circumferential surface tapering towards the bottom of the cavity with a cone angle between 12 degrees and about 20 degrees.

18. The method according to claim 1, wherein the papers for the individual layers have varying or equal thickness.
